(19) United States
(12) Patent Application Publication
(10) Pub. No.: US 2004/0120673 A1
(43) Pub. Date: Jun. 24, 2004

(54) Method of polishing polymer facets on optical waveguides

(75) Inventors: Christoph Georg Erben, Berkeley Heights, NJ (US); Howard Edan Katz, Summit, NJ (US); David J. McGee, Bethlehem, PA (US); Mark Lee, Berkeley Heights, NJ (US)

Correspondence Address: Glen E. Books, Esq., Lowenstein Sandler, 65 Livingston Avenue, Roseland, NJ, 07068, US

(73) Assignee: LUCENT TECHNOLOGIES

(21) Appl. No.: 10/323,370

(22) Filed: Dec. 19, 2002

(51) Int. Cl. G02B 6/10

(52) U.S. Cl. 385/129; 385/147

(57) ABSTRACT

In accordance with the invention, an optical waveguide device having a polished polymer end facet for low loss optical coupling is made by the steps of providing a polymer optical waveguide workpiece comprising a substrate and an overlying waveguiding structure formed of one or more layers of polymer softer than the material of the substrate. A cover layer of a material harder than the polymer is then secured overlying the polymer layers, and one or more polymer end facets are polished. The cover layer and the substrate guide the polishing so that the resulting facets have a flat, smooth surface.

### FIELD OF THE INVENTION

This invention relates to optical waveguides and, in particular, to a method of making planar optical waveguides that have polished polymer end facets for low loss optical coupling.

### BACKGROUND OF THE INVENTION

As optical fiber communications channels increasingly replace metal cable and microwave transmission links, integrated optical devices for directly processing optical signals become increasingly important. A particularly useful approach to optical processing is through the use of integrated waveguide structures formed on planar substrates. One way of making such planar waveguide structures is to form successive layers of silica on a silicon substrate. A doped silica core layer is patterned on an underlying silica cladding layer and an overlying cladding layer is formed over the core. The core layer is doped to a higher refractive index than the cladding and is typically patterned by photolithographic techniques. This approach is described in greater detail in C. H. Henry, et al, “Glass Waveguides on Silicon for Hybrid Optical Packaging,” 7 J. Lightwave Technol., pp. 1530-1539 (1989), which is incorporated herein by reference. Depending on the precise configuration of the patterned core, such devices can perform a wide variety of functions such as beam splitting, tapping, multiplexing, demultiplexing, filtering and modulating.

Currently, there is considerable interest in a new class of planar optical waveguides using organic polymer layers rather than silica layers on a rigid substrate. Such polymer waveguide devices are typically built as a series of organic thin films on a flat, hard substrate such as a silicon wafer or a glass slide. They are particularly promising for use in thermo-optic switches and optical modulators.

In an optical communication system, a polymer waveguide device is typically coupled to an optical transmission fiber, i.e. one or more polymer waveguide cores are coupled to abutting cores of optical fiber. Efficient, low-loss coupling typically requires the abutment of clean, high-quality polished surfaces.

Unfortunately it has been difficult to efficiently couple polymer waveguide devices to optical fiber. As compared with the silica used in optical fibers and conventional planar waveguides, polymer films are soft and difficult to polish. Attempts to polish end facets on a polymer planar waveguide are often unsuccessful. The polishing frequently chips or otherwise damages the end surfaces so that optical coupling losses are unacceptably high.

Accordingly, there is an improved need for a method of making planar polymer waveguides having quality end facets for low loss optical coupling.

### SUMMARY OF THE INVENTION

In accordance with the invention, an optical waveguide device having a polished polymer end facet for low loss optical coupling is made by the steps of providing a polymer optical waveguide workpiece comprising a substrate and an overlying waveguiding structure formed of one or more layers of polymer softer than the material of the substrate. A cover layer of a material harder than the polymer is then secured overlying the polymer layers, and one or more polymer end facets are polished. The harder cover layer and the substrate are substantially unabraded by mechanical action sufficient to polish the polymer. They guide the polishing so that the resulting facets in the waveguiding structure have a flat, smooth surface.

### BRIEF DESCRIPTION OF THE DRAWINGS

The advantages, nature and various additional features of the invention will appear more fully upon consideration of the illustrative embodiments now to be described in detail in connection with the accompanying drawings. In the drawings:

FIG. 1 is a schematic block diagram of a method of making an optical waveguide device having polished polymer end facets for low loss optical coupling;

FIGS. 2A, 2B and 2C are schematic cross sections of a polymer optical waveguide device at various stages of the process of FIG. 1; and

FIGS. 3A, 3B and 3C illustrate typical waveguide devices which can be fabricated with polished polymer end facets in accordance with the method of FIG. 1.

It is to be understood that these drawings are for purposes of illustrating the concepts of the invention and are not to scale.

### DETAILED DESCRIPTION

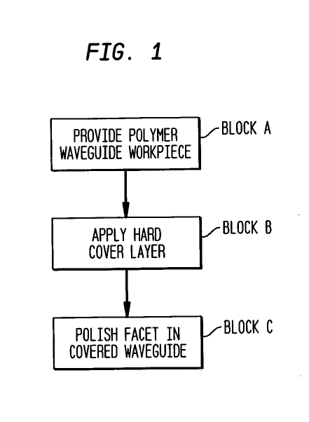

Referring to the drawings, FIG. 1 is a block diagram of a method of making an optical waveguide device having polished polymer end facets for low loss optical coupling. The first step, shown in Block A, is to provide a polymer optical waveguide workpiece comprising a substrate and a waveguiding structure formed of one or more polymer layers overlying the substrate. As compared with the substrate, the polymer layers are softer and more easily abraded.

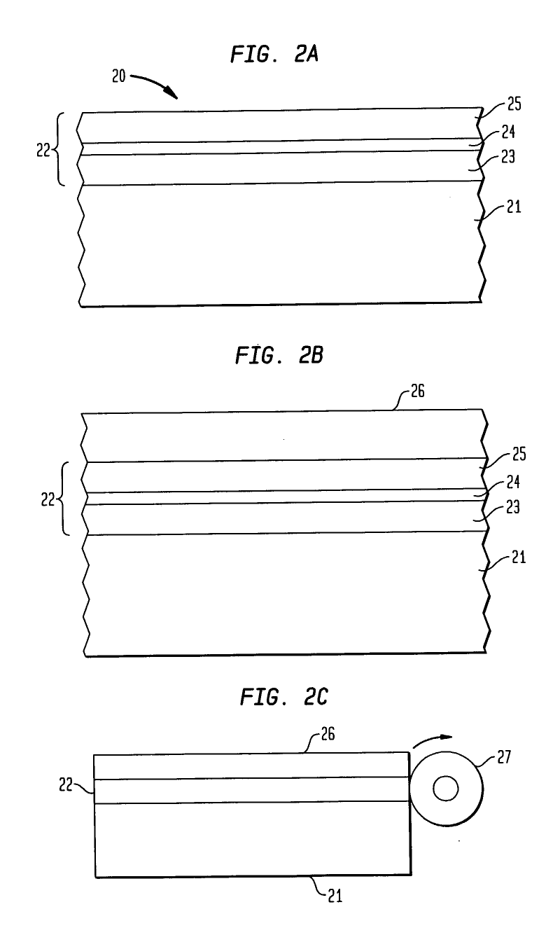

FIG. 2A illustrates a typical polymer optical waveguide workpiece 20 comprising a substrate 21. Disposed on and supported by a major surface of the substrate 21 is a waveguiding structure 22 comprising a patterned core layer of polymer 24. The patterned core layer 24 is substantially surrounded by lower index cladding material such as a lower cladding layer 23 and an upper cladding layer 25. Layers 23, 25 can be polymers. The core polymer has a higher index of refraction than the surrounding cladding so that the core will guide light. The core polymer is patterned in accordance with techniques well known in the art to process a light beam, e.g. to direct the beam, to split the beam, to filter the beam and/or to switch the beam path. The core polymer layer 24 can be any one of a variety of polymers including (meth)acrylate, epoxy, polyimide, silsesquioxane, polyether or cyclic olefin. The polymers will typically contain additives known in the art to impart optical properties, mechanical properties, chemical properties, chemical stability or to control crosslinking. The substrate 21 can comprise silicon or glass, and the cladding layers can be materials similar to the substrate, the cover or the core polymer chosen or modified to a lower refractive index.

The next step in the process shown in Block B of FIG. 1 is to secure over the polymer waveguiding structure 22 a cover layer of a material harder than the polymer. By harder than the polymer is meant that the cover layer is substantially unabraded by mechanical action sufficient to polish the polymer. Advantageously the cover layer has a hardness equal to or larger than the substrate and is secured to the waveguide structure as by bonding with adhesive.

FIG. 2B shows a cover layer 26 secured over the polymer waverguiding structure of the FIG. 2A workpiece. Conveniently the cover layer 26 can be a thin glass slide.

The next step, shown in Block C of FIG. 1 is to form one or more polished facets in the covered waveguide. The substrate and cover typically have thin dimensions transverse to respective major surfaces, and the polishing motion typically comprises polishing transverse to the major surfaces. In this instance, the harder edges of substrate and cover guide the polishing so that the resulting facets in the polymer have a flat, smooth surface.

FIG. 2C illustrates such polishing of the FIG. 2B structure as by a polishing wheel 27. Advantageously, the polishing motion is approximately transverse to the major surfaces of the substrate and the cover.

In a preferred embodiment, the substrate 21 has sufficiently large area to permit the core patterning of a plurality of functional waveguiding devices on the substrate. The substrate can then be scribed and diced into a plurality of individual devices which can be polished as described. With appropriate design, many of the facets can be polished prior to dicing.

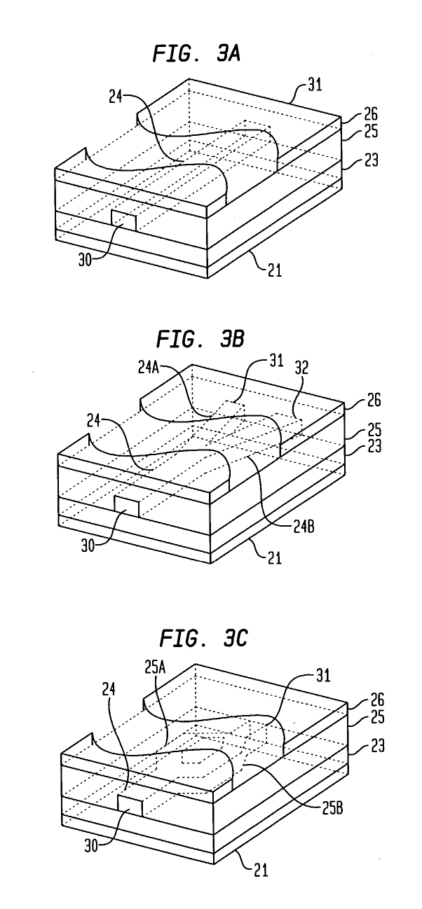

FIGS. 3A, 3B and 3C illustrate typical wavelength devices which can be fabricated with polished polymer end facets by the method of FIG. 1. FIG. 3A illustrates a simple optical waveguide wherein the patterned polymer core 24 extends across the device from one edge facet 30 to another 31. One or both of facets 30 and 31 can be polished in accordance with the method of FIG. 1 . In typical use, optical fibers (not shown) are coupled to the waveguide with the fiber cores abutted to the polymer cores at the polished facets.

FIG. 3B shows a simple Y-branched waveguide wherein the patterned polymer core 24 divides into two branches 24A, 24B, providing the possibility of three edge facets 30, 31 and 32. One or more of the facets can be polished in accordance with the invention. As is known in the art, Y-branch structure can be modified to act as a thermo-optic switch by coupling heaters (not shown) to the branches 24A, 24B.

FIG. 3C illustrates a simple Mach-Zehnder interferometer waveguide device wherein the patterned polymer core 24 divides between two arms 25A and 25B and then reunites. If there is an optical path length difference between the two arms, the device acts as a simple interferometer useful, for example, as part of an electro-optical modulator or demodulator. The core polymer presents two edge facets 30, 31 which can be polished in accordance with the method of FIG. 1. The interferometer can be made adjustable by coupling heaters (not shown) to one or both arms 25A, 25B.

The invention may now be more clearly understood by consideration of the following specific examples.

### EXAMPLE 1

Substrate: Si wafer;

lower cladding: Silsesquioxane (GR630S from Techneglas, Perrysburg, Ohio), 3 microns thick;

the copolymer is a 9:1 random copolymer of methyl methacrylate and 2-hydroxyethyl methacrylate, crosslinked with 4,4′-methylenebis(phenyl isocyanate).

core: PMMA/HEMA copolymer; 2 microns;

upper cladding: Silsesquioxane;

bonding: Norland NOA61 optical adhesive, less than 1 micron thick;

cover: Thinglass AF45 or D263T from Schott Glass or 2311 from Corning, typically 70-100 microns thick.

### EXAMPLE 2

Substrate: Quartz wafer; 500 microns thick

lower cladding: crosslinked methacrylate, 3 microns,

core: amorphous polycarbonate, 2 microns;

upper cladding: crosslinked methacrylate, 3 microns;

bonding: M-bond 610 from Allied High Tech Products Inc., less than 1 micron thick;

cover: Thinglass AF45 or D263T from Schott Glass or 2311 from Corning, typically 70-100 micron thick.

It is understood that the above-described embodiments are illustrative of only a few of the many possible specific embodiments, which can represent applications of the invention. Numerous and varied other arrangements can be made by those skilled in the art without departing from the spirit and scope of the invention.

What is claimed is:

1. A method of making a planar optical waveguide device comprising the steps of:
providing a polymer optical waveguide workpiece comprising a substrate having a major surface supporting an optical waveguiding structure comprising a patterned polymer core layer laterally surrounded by cladding material, the optical waveguiding structure composed of polymer softer than the substrate;
adhering overlying the waveguiding structure, a cover layer having a hardness greater than the waveguiding structure; and
polishing an end facet in the waveguiding structure using edges of the substrate and cover to guide the polishing.

2. The method of claim 1 wherein the cladding material comprises polymer material having a lower refractive index than the core polymer.

3. The method of claim 1 wherein the polishing is substantially transverse to the major surface.

4. The method of claim 1 wherein the cover has a hardness equal to or greater than the substrate.

5. The method of claim 1 wherein the substrate comprises silicon or glass.

6. The method of claim 2 wherein the cladding material comprises an underlying polymer cladding layer and an overlying polymer cladding layer.

7. The method of claim 1 wherein the waveguiding structure comprises a polymer selected from the group consisting of acrylates, epoxies, polyimides, silsesquioxanes, polyethers and cyclic olefins.

8. The method of claim 1 wherein the cover layer comprises a glass layer.

9. The method of claim 1 wherein the cover layer is adhesively bonded to the waveguiding structure.

10. A planar optical waveguide device comprising:
a substrate;
an optical waveguide having first and second surfaces, the first surface being adjacent to the substrate; and
a cover layer being adjacent to the second surface of the optical waveguide; and
wherein the optical waveguide comprises a polymer material and the substrate and cover layer comprise materials that are substantively unabraded by mechanical action sufficient to polish the polymer.

11. The apparatus of claim 10, wherein the apparatus includes a smooth end face across the substrate, optical waveguide, and rigid cover layer.

12. The apparatus of claim 10, further comprising:
a layer of adhesive bonding the cover layer to the optical waveguide.

13. The apparatus of claim 10, wherein the optical waveguide includes two optical cladding layers and an optical core layer disposed between the two optical cladding layers.
